(19) United States
(12) Patent Application Publication
(10) Pub. No.: US 2024/0404501 A1
(43) Pub. Date: Dec. 5, 2024

(54) Method and Apparatus for Emulating an Internal Combustion Engine Vehicle Audio Experience in an Electric Vehicle

(71) Applicant: Vincent Loccisano, Wellesley, MA (US)

(72) Inventor: Vincent Loccisano, Wellesley, MA (US)

(21) Appl. No.: 18/783,576

(22) Filed: Jul. 25, 2024

(51) Int. Cl. G10K 15/04; B62D 1/04

(52) U.S. Cl. CPC G10K 15/04; B62D 1/04

(57) ABSTRACT

A method and apparatus enables modifying the electronic controls of EVs to mimic the sensory experience of driving a performance ICE car. The method and apparatus creates a “virtual cockpit” with audio enhancement with sounds that mimic those of an ICE car. By downloading and implementing the method and apparatus, one may replicate, for example, the vehicle dynamics, performance horsepower sound, cabin sound, subtle cabin vibrations, exterior wind sound, and audio cues that may be controlled via a graphical user interface. These simulations replicate the various sounds of an ICE vehicle to mimic the audio experience of driving an ICE performance car of choice.

### TECHNICAL FIELD

The present disclosure is an apparatus and method related to methods, circuits, or devices for controlling the electronic audio experience of electrically-propelled vehicles to achieve a desired performance; information or communication for improving the operation of electric vehicles. The apparatus and method involves arrangements of instruments for, and aspects of display of, information in a vehicle; non-manual adjustments, e.g. with electrical operation with logic circuits and with logic circuits using sensors or detectors for adapting control systems specially adapted for electric vehicles.

### BACKGROUND OF THE INVENTION

While electric vehicles (EVs) and hybrid vehicles offer environmental benefits by reducing greenhouse gas emissions and air pollution, some drivers find the driving experience to be unsatisfactory because there is little sensory feedback of the kind they are used to in traditional internal-combustion-engine (ICE) vehicles. Some consumers express a preference for the sound and vibration associated with traditional internal-combustion-engine (ICE) vehicles, whether out of nostalgia, a perception of a more engaging driving experience, or lack of feedback about vehicle performance in EVs.

Automobile electronics, including computers, electrical cables, and software protocols, are together known as a Controller Area Network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control unit (ECU). Current EVs may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Vibration is commonly produced electronically with either DC eccentric rotating mass (ERM) motors. ERM motors are typically DC motors with a non-concentric weight on the motor shaft. Spinning the DC motor moves the weight and creates a vibration as the weight rotates about the shaft central axis. One skilled in the art understands that various mechanisms may be used to cause vibration a generic term for such devices is vibratory actuator. Vibration may also be simulated by a subwoofer that is capable of producing nondirectional vibratory bass sounds. A subwoofer/vibratory actuator may be placed anywhere in the vehicle to provide a vibratory experience equally to any passenger in the vehicle.

Patents and products in the current state of the EV art mimic some of the performance characteristics and exterior sounds of internal-combustion cars. Controls and customizability of the experience are limited and may not be feasible for all vehicle makes and models.

Subsystems can be electronically operated through a central control that can be modified by a driver, but the loss of mechanical sound and feel may disappoint driving enthusiasts, who may come to view their EV as an appliance rather than a car.

A customizable and adaptable system that caters to the preferences of car enthusiasts would offer a responsive, sensory experience like that of performance cars.

### SUMMARY OF THE INVENTION

A method and apparatus enables modifying the electronic controls of EVs to mimic the sensory experience of driving a performance ICE car. The method and apparatus creates a “virtual cockpit” with audio enhancement with sounds that mimic those of an ICE car. By downloading and implementing the method and apparatus, one may replicate, for example, the vehicle dynamics, performance horsepower sound, cabin sound, subtle cabin vibrations, exterior wind sound, and audio cues that may be controlled via a graphical user interface. These simulations replicate the various sounds of an ICE vehicle to mimic the audio experience of driving an ICE performance car of choice.

The method and apparatus's algorithm may be downloaded into any of an EV's ECUs, CAN, LIN, or Ethernet platform to simulate aspects of an ICE. Modern EVs have internet connectivity controlled by a dashboard touch-screen. One skilled in the art is familiar with electronic communications and various connection methods for downloading and inputting information from a smart device or directly from the EV onboard computer and interface. The method and apparatus creates a virtual cockpit that simulates a particular ICE vehicle, toggling between EV and ICE experience, enabling, for example, the sound of a specific performance ICE engine and transmission as the EV progresses through changing speeds.

In one embodiment, a vehicle manufacturer maps its factory-supported, brand-specific system commands to the algorithms of the method and apparatus to render the EV an immersive ICE simulation that is layered over EV technology. Mapping an audio experience of an ICE performance vehicle may include recording the sound of the engine, transmission, turbo and differential at various speeds under various rates of acceleration and deceleration, in various gears. ICE performance vehicle aspects—engine type, number of cylinders, engine volume, turbo settings, transmission type and cabin vibration—exterior sounds including wind noise, road noise—are all measured and recorded from an actual ICE performance vehicle and input to an algorithm that may be uploaded to the EV CAN. A driver interested in replicating the audio experience of driving a 1960s Jaguar E-Type Roadster might choose to purchase the manufacturer's modified sound system commands specific to that vehicle, or might choose to use the method and apparatus to alter the factory-provided CAN to simulate that audio experience. High performance ICE vehicles have straight cut gears that make a distinctive whine-like noise. A driver may choose a specific race car or may add the racing transmission sound to an existing ICE performance vehicle program.

An iteration has additional ICE-related auditory cues; including: recorded tire noise; differential noise; turbocharger noise; road noise; transmission noise in each gear and RPM; and wind noise. Accounting for engine type, transmission type and cabin vibration, these are played in the vehicle cabin and respond to actual acceleration. Transmission noise replicates that of an ICE racecar's transmission, with the signature whine of straight-cut gears.

All of these auditory cues could be in addition to the ICE drivetrain noises, separate from, or some combination thereof.

Vibratory actuators my include rotary motion in the seat and/or steering wheel and/or floor matt of an EV and may be programed to mimic the vibration of an ICE performance vehicle to complement the sound effects. One skilled in the art understands that vibratory actuators may be factory installed or an after-market installation. Engine and transmission sounds and vibrations may, for example, mimic the sound and feel of the Jaguar Roadster in first gear as the EV is driven from a stop to 5 mph when the sound and vibration mimic the engine and transmission revving at the same RPM that the Jaguar Roadster would at the same speed in first gear. The shift to second gear may then be mimicked in sound and vibration at the appropriate speed, and so on, as the vehicle moves from stopped to highway speed. The same may occur in reverse as the driver slows from a given speed to a stop.

Vibration actuators may be configured to perform other functions when not used to create an ICE performance-vehicle experience. In some embodiments vibration actuators are configured to augment an EV alert system to alert a driver of an incoming phone call or to signify that the driver has been driving for a significant number of hours or the like.

This audio experience may be mapped from any number of ICE performance vehicles so that a user may experience classic sports cars like a Porsche 911 or a classic luxury vehicle such as the 1963 Maserati Quattroporte S1, a performance sedan. The audio experience may respond to a driver's style, creating the sound of an aggressively shifted ICE performance vehicle when the driver accelerates rapidly, or the sound of downshifting as a driver decelerates rapidly.

### BRIEF DESCRIPTION OF DRAWINGS

FIG. 1 is a flowchart of a method of the disclosure.

FIG. 2 is an illustration of the interior of an EV showing vibratory actuator locations.

### DETAILED DESCRIPTION

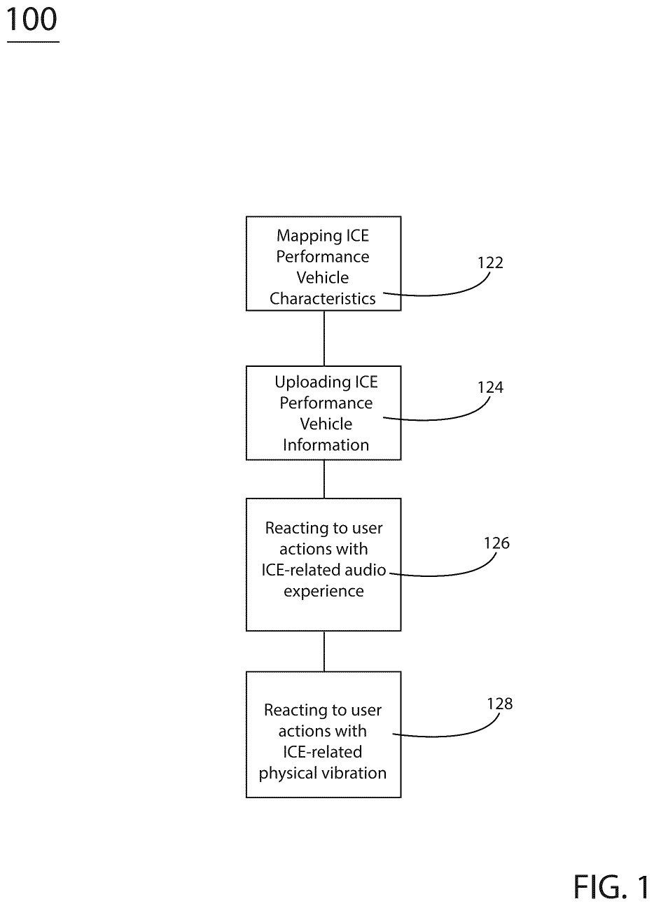

In FIG. 1, a method includes: mapping ICE-performance-vehicle characteristics 122 including recording the sound at different speeds and the relationship between vehicle speed, engine RPM, transmission RPM and each gear, for various acceleration and deceleration rates. Uploading ICE performance vehicle information 124 is done by electronically coupling the EV onboard computer system with an internet connection or another device that holds the mapped information in the form of a software program upgrade to existing EV software. The uploaded information controls the EV sound system by reacting to user actions to create an ICE performance vehicle experience 126. The uploaded information controls EV sound system components such as a subwoofer to create vibrations throughout the vehicle. The uploaded information also controls the vibratory actuators by reacting to user actions with ICE-related physical vibration 128. One skilled in the art understands that vibration may be created by either a subwoofer that creates non-directional vibration throughout the vehicle or by individual vibration actuators.

User actions are measured by the software package and are guided by the mapped ICE-performance-vehicle characteristics and may include determining the acceleration or deceleration rate of the vehicle by measuring change in speed over time. The acceleration or deceleration rate is paired with the sound that a specific ICE performance vehicle would likely exhibit when accelerating at a similar rate. The sound and vibration of the appropriate gear changes, engine, transmission and turbo response to a given acceleration or deceleration rate create a virtual ICE-performance-vehicle experience.

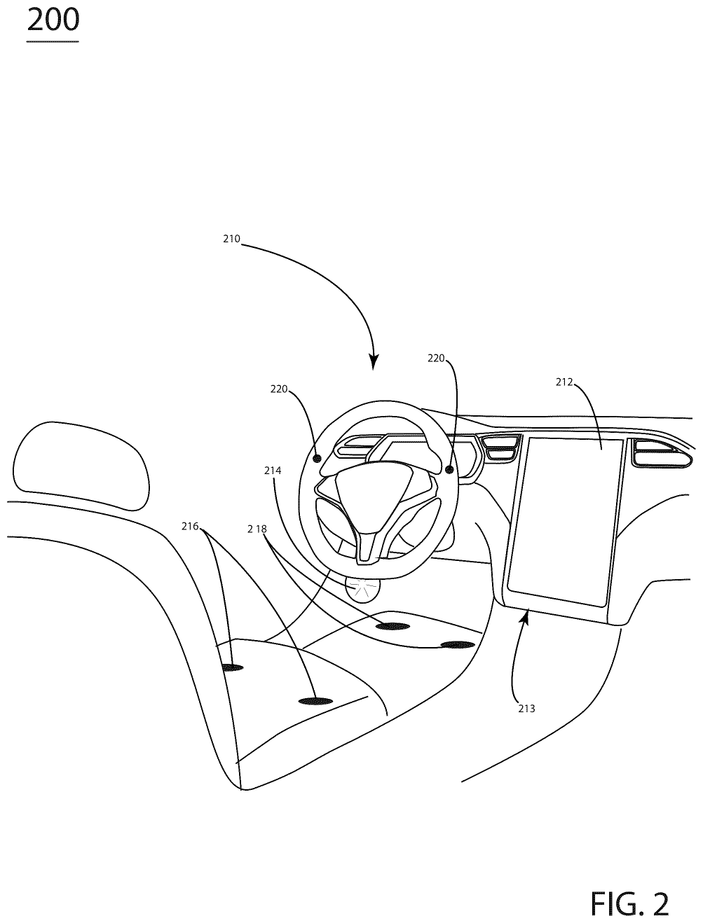

FIG. 2 is an illustration of an example EV interior 210. Audio features of the embodiment function through factory-installed EV audio systems, including controls on a touch screen 212 and speakers 214. Vibratory actuators are illustrated mounted in a seat 216 while others are mounted in the steering wheel 220 and yet other vibratory actuators are mounted in the floor mat 218. In some embodiments, vibratory actuators are mounted during factory assembly of the vehicle. Factory-mounted vibratory actuators may be used in the normal use of the vehicle as an alert mechanism. Vibratory actuators may work in conjunction with audio alarms to signify an incoming phone call, an unfastened seat belt, objects in close proximity to the vehicle and the like. Vibratory actuators may be installed as an aftermarket product in replacement floor mats, seat covers or a steering wheel cover wherein a wireless connection to the vehicle computer provides communication to the vehicle systems that control alarms when not used as part of the audio tactile experience.

1. An apparatus for emulating an internal-combustion-engine-performance vehicle audio experience in an electric vehicle, comprising:
a software compatible with and able to be uploaded to an electric-vehicle control computer, including a mapping of the audio experience of an internal-combustion-engine-performance vehicle; wherein
said software uses the electric vehicle sound system to play the sound of an internal-combustion-engine-performance vehicle in response to user actions in the electric vehicle.

2. The apparatus of claim 1 wherein:
said software is includes sounds mapped from a specific internal-combustion-engine-performance vehicle; and
said software applies said sounds created by given actions performed in said internal-combustion-engine-performance vehicle to similar actions performed in said electric vehicle.

3. The apparatus of claim 1 further comprising:
vibratory actuators in communication with the cockpit of said electric vehicle; wherein
said vibratory actuators provide vibration, controlled by said software, to mimic vibrations in said internal-combustion-engine-performance vehicle when given actions are performed, according to similar actions performed in said electric vehicle.

4. The apparatus of claim 3 wherein:
the vibratory actuator is a subwoofer/vibratory actuator.

5. The apparatus of claim 3 further comprising:
eccentric-rotating-mass motor vibratory actuators in the steering wheel of said electric vehicle; wherein
said vibratory actuators provide vibration, controlled by said software, to mimic vibrations in said internal-combustion-engine-performance vehicle when given actions are performed, according to similar actions performed in said electric vehicle.

6. The apparatus of claim 3 further comprising:
eccentric-rotating-mass motor vibratory actuators in the floor of said electric vehicle; wherein:
said vibratory actuators provide vibration, controlled by said software, to mimic vibrations in said internal-combustion-engine-performance vehicle when given actions are performed, according to similar actions performed in said electric vehicle.

7. A method for using the apparatus of claim 1, the method comprising:
mapping audio characteristics of an internal-combustion-performance vehicle; and
writing a software package including said audio characteristics; and
uploading said software to an electric vehicle controller area network system; and
playing said audio characteristics through an audio system connected to said vehicle-controller-area network system in said electric vehicle in response to user actions in said electric vehicle.

8. The method of claim 7 wherein:
the audio system provides an audio experience to the interior of the electric vehicle.

9. The method of claim 7 wherein:
the audio system provides an audio experience to the exterior of the electric vehicle.

10. The method of claim 7, said mapping further comprising:
recording audio of said internal-combustion performance vehicle driven in each gear at at least one speed and rate of acceleration; and
playing said audio when said electric vehicle is driven in the speed that is in the range of said each gear at said at least one rate of acceleration.

11. The method of claim 7, said mapping further comprising:
recording audio of a turbocharger of said internal-combustion-performance vehicle at at least one speed and rate of acceleration, and playing said audio through said audio system connected to said vehicle controller area network.

12. The method of claim 7, said mapping further comprising:
recording audio of a differential of said internal-combustion-performance vehicle at at least one speed and rate of acceleration; and playing said audio through said audio system connected to said vehicle controller-area network.

13. The method of claim 7, said mapping further comprising:
recording audio of a transmission of said internal-combustion-performance vehicle at at least one speed and rate of acceleration, and playing said audio through said audio system connected to said vehicle controller area network.

14. The method of claim 7, said mapping further comprising:
recording audio of tire noise of said internal-combustion-performance vehicle at at least one speed and rate of acceleration, and playing said audio through said audio system connected to said vehicle controller area network.

15. The method of claim 7, said mapping further comprising:
recording audio of wind noise of said internal-combustion-performance vehicle at at least one speed, and playing said audio through said audio system connected to said vehicle controller-area network.

16. The method of any of claims 10-15 further comprising:
matching actual speed and rate of acceleration in said electric vehicle to specific sounds associated with the speed and rate of acceleration in the ICE performance vehicle recorded sounds.
